(19) United States
(12) Patent Application Publication
(10) Pub. No.: US 2006/0201441 A1
(43) Pub. Date: Sep. 14, 2006

(54) Bird cage

(76) Inventor: Caeol Frank, Dallas, TX (US)

Correspondence Address: JOHN A. THOMAS;Glast, Phillips & Murray, 2200 One Galleria Tower, 13355 Noel Road, LB 48, Dallas, TX, 75240-1518, US

(21) Appl. No.: 11/080,362

(22) Filed: Mar. 14, 2005

(51) Int. Cl. A01K 31/06

(52) U.S. Cl. 119/462

(57) ABSTRACT

A bird cage has a top grill, a front grill, at least two side grills, and a base. The top, bottom, and side grills and the base define an interior space. A playpen for the cage has a drawer located between the base and the interior space. The drawer is slidable between the interior space and the exterior of the bird cage. There is also a bottom grill that is slidable in and out within in the drawer, to give access to the playpen drawer for cleaning. The playpen preferably includes a perch, a toy hook, and water and food dishes.

### TECHNICAL FIELD

This invention relates to bird cages, particularly bird cages having removable parts.

### BACKGROUND

Bird cages are well known in the art. They house one or more birds and may contain a wide variety of perches, swings, and amenities such as seed trays, gravel trays, water trays, baths, toys, and the like. One important consideration in bird cage design is the ease with which the cage may be cleaned, and another is a means to allow the bird to play freely or fly out of the cage in the proper environment. What is needed is a cage having a removable play area that also allows easy cleaning.

### DRAWINGS

FIG. 1 shows a perspective view of the bird cage of the preferred embodiment. The playpen is located inside the cage and partly protruding therefrom.

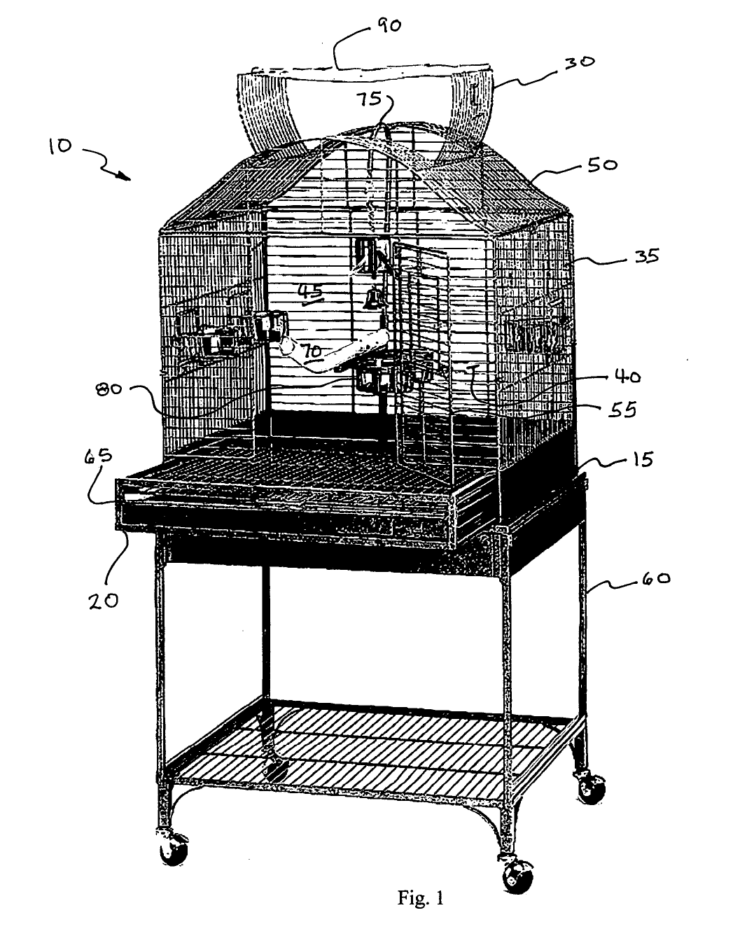

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. whereas a multiplicity of bases can be latched together.

13. (canceled)

14. (canceled)

15. (canceled)

16. (canceled)

17. (canceled)

18. A bird cage, the bird cage comprising:
a top grill;
a front grill;
at least two side grills; and,
a base;
the top, bottom, and side grills and the base defining an interior space; and,
a playpen; the playpen further comprising:
a drawer located between the base and the interior space;
the drawer slidable between the interior space and the exterior of the bird cage; and,
a bottom grill; the bottom grill slidable within the drawer.

19. The bird cage of claim 1 further comprising:
a top hatch; the top hatch opening in the top grill.

20. The bird cage of claim 1 further comprising:
an auxiliary perch; the auxiliary perch located above the top hatch.

21. The bird cage of claim 1 further comprising:
a perch connected to the playpen.

22. The bird cage of claim 1 further comprising:
a toy hook connected to the playpen.

23. The bird cage of claim 1 further comprising:
water and food dishes connected to the playpen.

24. The bird cage of claim 1 further comprising:
a front door.

25. The bird cage of claim 1 further comprising:
a stand for supporting the bird cage.

26. A bird cage, the bird cage comprising:
a top grill;
a front grill;
two side grills; and,
a base;
the top, bottom, and side grills and the base defining an interior space; and,
a playpen; the playpen further comprising:
a drawer located between the base and the interior space;
the drawer slidable between the interior space and the exterior of the bird cage;
a bottom grill; the bottom grill slidable within the drawer;
a perch and a toy hook connected to the playpen;
a top hatch; the top hatch opening in the top grill; and,
a front door.
